(19) United States
(12) Patent Application Publication
(10) Pub. No.: US 2014/0190620 A1
(43) Pub. Date: Jul. 10, 2014

(54) LAYER SYSTEMS AND METHODS USING SUCH LAYER SYSTEMS

(71) Applicant: Cetin Vural, Erding (DE)

(72) Inventor: Cetin Vural, Erding (DE)

(21) Appl. No.: 14/144,156

(22) Filed: Dec. 30, 2013

Related U.S. Application Data
(63) Continuation of application No. PCT/EP2012/002804, filed on Jul. 2, 2012.
(60) Provisional application No. 61/503,928, filed on Jul. 1, 2011.

(30) Foreign Application Priority Data
Jun. 30, 2011 (DE) 102011106156.1

(51) Int. Cl. B32B 7/12; B32B 37/00

(52) U.S. Cl. CPC B32B 7/12; B32B 37/025
USPC 156/152; 428/41.8; 428/41.7

(57) ABSTRACT

A layer system comprises an application layer assembly including a functional layer and an adhesive for adhering the application layer assembly to a carrier, and a transport layer assembly including a carrier layer and an adhesive for adhering the transport layer assembly to the application layer assembly. The application layer assembly can be applied to the carrier by adhering the layer system to the carrier; correcting a position of the layer system relative to the carrier by releasing the adhesive adherence of the application layer assembly to the carrier by pulling at least one tab of the transport layer assembly in a first direction; re-adhering of the layer system to the carrier; and releasing the transport layer assembly from the application layer assembly by pulling the at least one tab of the transport layer assembly in a second direction different from the first direction.

### RELATED CASE

This application is a continuation application of, and hereby claims priority under 35 U.S.C. §120 to, pending International PCT Application No. PCT/EP2012/002804, filed on Jul. 2, 2012. PCT Application PCT/EP2012/002804 itself claims priority to U.S. Provisional Patent Application No. 61/503,928, filed on Jul. 1, 2011, and to German Patent application DE 10 2011 106 156.1, filed on Jun. 30, 2011. The above-listed applications are hereby incorporated by reference.

### FIELD

The invention relates to a layer system for application to a carrier, wherein the layer system comprises plural layers which may include a protective layer, an adhesive, a decorative layer and other layers. The carrier can be any article, in particular a solid article, and may include a technical apparatus, for example. The layer system applied to the carrier may provide protective functions, decorative functions or other function. The invention further relates to methods of applying such layer system to a carrier.

### BACKGROUND

Conventional layer systems are applied to articles as films for various purposes. For example, a layer system applied to an article may included coloured patterns for decorative or information purposes. For example, coloured patterns and legends of a film applied to an operator panel of an apparatus may guide a user in operating the apparatus. Moreover, it is quite common to adhere decorative films to mobile phones and tablet computers in order to improve their appearance. It is also quite common to adhere a transparent protective film to displays of certain mobile phones having a large display, such as the iPhone™, or to tablet computers, such as the iPad™. Such film type layer systems comprise an adhesive in order to adhere a functional layer, such as a transparent protective layer or a coloured decorative layer, to the carrier. Herein, the dimensions of the functional layer are adapted to the geometry of the carrier.

It is often difficult to apply the functional layer in its desired position on the carrier. Moreover, it is in particular difficult to release a functional layer which has been inadvertency applied to the carrier adjacent to or displaced from its target position in first try from the carrier and to correctly re-adhere the functional layer to the carrier in a next try. Conventional films allowing removal from the carrier and re-adhering to the carrier subsequent to full application or partial application to the carrier must have a sufficient rigidity and, accordingly, a significant thickness. It is, however, desirable that such films have a low thickness in order to fulfil their decorative functions and their practical function, since the films are exposed to increased mechanical wear at their edges, such that the films may start at their edges to separate from the carrier during normal use.

The present invention has been made in order to overcome the above deficiencies.

### SUMMARY

Embodiments of the invention provide a layer system comprising a functional layer for application to a carrier, wherein the layer system allows a correction of a position of the functional layer relative to the carrier and wherein the functional layer can be relatively thin.

According to certain embodiments, a layer system comprises an application layer assembly for application to a carrier, wherein the application layer assembly comprises at least one functional layer and at least one adhesive applied to at least portions of the functional layer, wherein the adhesive is configured to adhesively adhere the application layer assembly to the carrier. The layer system further comprises a transport layer assembly comprising at least one carrier layer and at least one adhesive applied to at least portions of the carrier layer and adhesively adhering the transport layer assembly to the application layer assembly.

Herein, the application layer assembly is provided for application to the carrier such that it remains on the carrier. The transport layer assembly is provided to carry the application layer assembly while the application layer assembly is not yet finally applied to the carrier and for providing manipulation means in the process of applying the application layer assembly to the carrier. When the application layer assembly is finally applied to the carrier, the transport layer assembly is released from the application layer assembly such that only the application layer assembly remains on the carrier. The functional layer may then provide a protective function or decorative function to the carrier.

According to some embodiments, the transport layer assembly comprises a release tab and a correction tab provided on different sides of the transport layer assembly. The release tab and the correction tab project from the application layer assembly such that they can be grasped by the hand of a user without grasping the application layer assembly.

When the layer system is adhered to the carrier by the adhesive provided on the functional layer, the release tab and the correction tab serve for different purposes: The user may grasp the release tab with his hand, for example, and pull the release tab in a first direction such that the carrier layer is released from the application layer assembly. By pulling the release tab, it is thus possible to completely release the carrier layer together with its adhesive from the functional layer, such that, finally, only the functional layer remains on the carrier. Moreover, the user may grasp the correction tab with his hand, for example, and may pull the correction tab in a second direction in order to release the transport layer assembly together with the functional layer from the carrier. It is, in particular, possible to partially or fully release the application layer assembly which has been partially or fully adhered to the carrier from the carrier and to subsequently re-adhere the application layer assembly to the carrier.

It is in particular possible, to apply the layer system to the carrier and to release the layer system from the carrier in the event, that the functional layer which should permanently remain on the carrier has not been positioned on the carrier as desired. The layer system can be released from the carrier by pulling the correction tab in the second direction. The position of the functional layer relative to the carrier can be corrected, and the functional layer can then be re-adhered to the carrier. When the functional layer is positioned relative to the carrier as desired, the carrier layer can be released from the functional layer by pulling the release tab in the second direction such that the application layer assembly remains on the carrier without the transport layer assembly.

According to some embodiments, the adhesive of the application layer assembly and the adhesive of the transport layer assembly are adjusted relative to each other such that the application layer assembly can be released from the carrier by pulling at the correction tab while the adhesive adherence of the transport layer assembly to the application layer assembly is maintained, and such that the transport layer assembly can be released from the application layer assembly by pulling at the release tab while the adhesive adherence of the application layer assembly to the carrier is maintained.

According to exemplary embodiments herein, the transport layer assembly includes one or more regions in which an adhesive force of the adhering of the transport layer assembly to the application layer assembly decreases in a correction direction extending from the correction tab to the release tab. The decrease of the adhesive force may occur continuously, i.e. without abrupt steps. There are various possibilities to achieve the reducing adhesive force of the adhering of the transport layer assembly to the application layer assembly.

According to particular embodiments, an adhesive force of the adhesive of the transport layer assembly decreases in the correction direction in the at least one region.

According to other particular embodiments, a neutralizing agent is provided in at least some portions between the adhesive of the transport layer assembly and the application layer assembly in order to reduce an adhesive force of the adhesive of the transport layer assembly.

According to still further particular embodiments, a repelling agent is provided in at least some portions of the application layer assembly in order to reduce the adhesive force of the adhesive of the transport layer assembly.

According to still further particular embodiments, the adhesive is provided only in portions of the surface region rather than the full surface of the surface region such that the adhesive force of the adherence of the transport layer assembly to the application layer assembly decreases in the correction direction.

According to a particular embodiment herein, the adhesive is provided in the at least one region only in a surface portion having a width decreasing in the correction direction. The width may, in particular, decrease continuously in the correction direction. The surface portion in which the adhesive is provided may have a triangular shape, for example.

According to a exemplary embodiments, the at least one region has an extension in a direction transverse to the correction direction from 2 mm to 20 mm, from 2 mm to 10 mm, or from 3 mm to 10 mm.

Thus, in the at least one region, in which the adhesive force of the adherence of the transport layer arrangement to the application layer arrangement decreases in the correction direction, it is possible that it is the adhesive force of the adhesive itself which decreases in the correction direction, it is possible that it is the surface proportion in which adhesive is provided on the transport layer assembly which decreases in the correction direction, it is possible that it is the activity and/or the surface proportion of a neutralizing agent reducing the adhesive force of the adhesive of the transport layer assembly which changes in the correction direction, or it is possible that it is the activity and/or the surface proportion of a repellent agent provided on the application layer assembly which changes in the correction direction.

According to exemplary embodiments, the layer system comprises one or more material discontinuities of the functional layer extending along at least one separation line, wherein at least a portion of the at least one separation line extends in a direction transverse to the correction direction. The material discontinuity has a function of weakening the material structure of the functional layer. The material discontinuity may be formed as a cut or press cut extending through a portion or the full thickness of the functional layer. The material discontinuity may continuously extend along the separation line, or a plurality of material discontinuities can be provided which extend along the separation line and which are spaced apart from each other along the separation line.

According to exemplary embodiments herein, the adhesive force of the adherence of the transport layer assembly to the application layer assembly has a value smaller than 0.2 times a maximum adhesive force of the adherence of the transport layer assembly to the application layer assembly in a first surface portion immediately adjacent to the separation line on a side facing towards the correction tab. This can be achieved, for example, in that no adhesive is provided in the first surface portion. This can be achieved, for example, in that a low amount of adhesive is provided in the first surface portion or in that the adhesive force of the adhesive provided in the first surface portion is reduced by a neutralizing agent. The maximum adhesive force is, in this context, the maximum adhesive force between the transport layer assembly and application layer assembly achieved at any location within the application layer assembly.

According to further exemplary embodiments herein, the adhesive force of the adherence of the transport layer assembly to the application layer assembly has a value greater than 0.8 times a maximum adhesive force of the adherence of the transport layer assembly to the application layer assembly in a second surface portion immediately adjacent to the separation line on a side facing towards the release tab. This can be achieved, for example, in that adhesive is provided over the full surface or the major surface of the second surface portion or in that an adhesive having a high adhesive force is provided in the second surface portion.

According to exemplary embodiments, the first surface region or the second surface region extend over a full length of the separation line when seen in a direction orthogonal to the correction direction. 14. The layer system according to one of claims 9 to 13, wherein the separation line has a shape of a closed ring and wherein the material discontinuity extends continuously along the separation line or wherein a plurality of spaced apart material discontinuities extend along the separation line.

According to further exemplary embodiments, surface portions having a very low or a very high adhesive force are also provided in regions immediately adjacent to the correction tab and the release tab, respectively. In particular, the adhesive force of the adherence of the transport layer assembly to the application layer assembly may have a value greater than 0.8 times a maximum adhesive force of the adherence of the transport layer assembly to the application layer assembly in a third surface portion immediately adjacent to the correction tab. Further, the adhesive force of the adherence of the transport layer assembly to the application layer assembly has a value smaller than 0.2 times a maximum adhesive force of the adherence of the transport layer assembly to the application layer assembly in a fourth surface portion immediately adjacent to the release tab. The third surface portion or the fourth surface portion may extend in a direction orthogonal to a correction direction across a full width of the application layer assembly, wherein the correction direction extends from the correction tab to the release tab.

According to some embodiments, the separation line has a shape of a closed ring. This may have an advantage if the functional layer remaining on the carrier should cover only portions of the carrier rather than the full surface of the carrier. The ring shaped separation line the defines a portion of the functional layer which is removed from the carrier together with the transport layer and which will not remain of the carrier.

According to further embodiments, the adhesive force of the adherence of the application layer assembly to the carrier is substantial smaller on a side of the material discontinuity facing inwardly with respect to the closed ring shaped separation line than on a side of the material discontinuity facing outwardly relative to the closed ring shaped separation line. This difference between the adhesive force of the adherence of the application layer assembly to the carrier within the ring shaped separation line and the adhesive force of the adherence of the application layer assembly to the carrier outside of the ring shaped separation line can be achieved in various ways: According to an example, this difference is achieved by a difference in the activity of the adhesive or a difference in the surface proportions at which the adhesive is provided. According to a further example, this difference is achieved by a difference in the activity of a neutralizing agent or a difference in the surface proportions at which neutralizing agent is provided on the adhesive of the application layer assembly.

According to some embodiments, the functional layer of the application layer assembly includes a light transparent protective layer and a decorative layer provided between the protective layer and the adhesive of the application layer assembly. The decorative layer can be designed such that the carrier has, subsequent to the application of the application layer arrangement, the desired decorative appearance. The protective layer may have a function to protect the decorative layer from damages, such as scratches.

According to exemplary embodiments, the decorative layer is made of a light absorbing material and, in particular, a coloured material, wherein the light absorbing properties and colour of the material can vary in a lateral direction of the decorative layer such that the decorative layer provides a colour pattern.

According to further exemplary embodiments, the decorative layer is made of a light reflective material, such as a material providing a metal type reflection and which can be, in particular, structured to provide a holographic diffracting effect to incident light. This is in particular possible, if distances between adjacent structural elements of the decorative layer are smaller than the wave lengths of visible light.

According to exemplary embodiments, the protective layer is directly applied to the decorative layer. According to other exemplary embodiments, an adhesive layer is provided between the protective layer and the decorative layer.

According to some embodiments, a thickness of the application layer assembly is less than 0.5 mm, less than 0.14 mm, less than 0.10 mm or less than 0.08 mm. Such low thicknesses of the application layer assembly can be advantageous if the functional layer includes only the decorative layer but no light transparent protective layer.

According to some other embodiments, the functional layer of the application layer assembly includes a light transparent protective layer, and the thickness of the application layer assembly is less than 0.30 mm, less than 0.20 mm or less than 0.15 mm.

According to some embodiments, the thickness of the application layer assembly is greater than 0.001 mm, greater than 0.005 mm or greater than 0.01 mm.

According to some embodiments, the thickness of the transport layer assembly is greater than 1.5 times or greater than 2.0 times the thickness of the application layer assembly.

According to some embodiments, the thickness of the transport layer assembly is greater than 0.05 mm, greater than 0.1 mm or greater than 0.2 mm.

According to particular embodiments, the carrier is a mobile phone or a tablet computer.

According to exemplary embodiments, a method of adhering an application layer assembly to a carrier, wherein a method comprises adhering a layer system to the carrier, wherein the layer system comprises an application layer assembly and a transport layer assembly, wherein the application layer assembly comprises at least one functional layer and an adhesive applied to at least a portion of the functional layer and configured to adhesively adhere the application layer assembly to the carrier, and wherein the transport layer assembly comprises at least one carrier layer and an adhesive applied to at least a portion of the carrier layer and adhesively adhering the transport layer assembly to the application layer assembly; correcting a position of the layer system relative to the carrier by releasing the adhesive adherence of the application layer assembly to the carrier by pulling at least one tab of the transport layer assembly in a first direction; re-adhering of the layer system to the carrier; and releasing the transport layer assembly from the application layer assembly by pulling the at least one tab of the transport layer assembly in a second direction different from the first direction.

According to some embodiments herein, the correcting of the position comprises pulling at a correction tab of the transport layer assembly provided on a first side of the transport layer assembly, and the releasing of the transport layer assembly comprises pulling at a release tab of the transport layer assembly provided at a second side of the transport layer assembly, wherein the second side is different from the first side.

According to some further embodiments, the correction tab and the release tab are provided on opposite sides of the transport layer assembly.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

It is pointed out that the invention is not restricted to the embodiments of the described exemplary embodiments, but is defined by the scope of the enclosed patent claims. In particular, the individual features including embodiments according to the invention can be realised in another quantity and combination than with the examples mentioned below. With the following explanation of some exemplary embodiments of the invention, reference is made to the enclosed Figures, of which

FIG. 1 is an elevational view of a layer system;

FIG. 2 is a cross-sectional view of a layer system and a carrier for illustrating a method of applying the layer system to the carrier;

FIG. 3 is an elevational view of the layer system shown in FIGS. 1 and 2 for illustrating adhesive regions;

FIGS. 4a to 4i are schematic illustrations of variations of adhesive regions which can be used in the layer system of FIG. 1;

FIG. 5 is an exploded sectional view of a layer system;

FIG. 6 is an exploded sectional view of a further layer system; and

FIG. 7 is an elevational view of a further layer system.

### DETAILED DESCRIPTION OF EXEMPLARY EMBODIMENTS

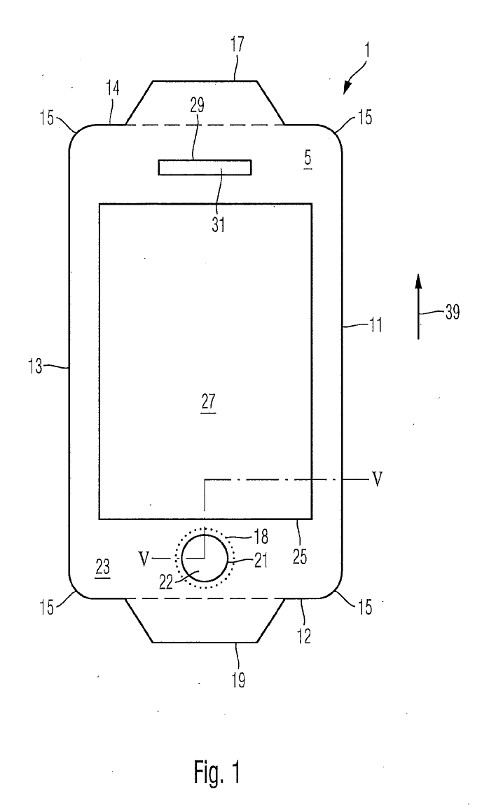

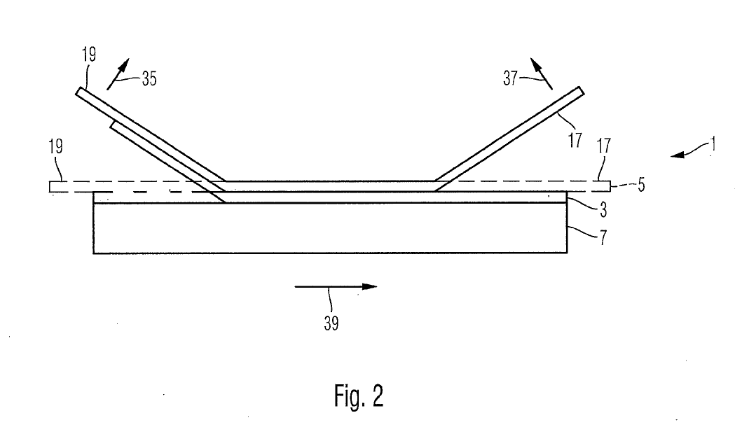

FIGS. 1 and 2 are schematic illustrations of a layer system for application to a carrier and of a method of applying an application layer assembly to a carrier. In the examples illustrated below, the carrier is the iPhone™ mobile phone available from Apple. This mobile phone has a relatively large display having a touch screen function, i.e. the display is touch-sensitive. Elements, such as a button, a microphone, a speaker and a camera are positioned within a frame surrounding the display. The display and the frame surrounding the display have a substantially flat surface.

Some users find it desirable to adhere a transparent protective film to the display in order to increase the durability of the apparatus. Other users find it desirable to apply a decorative film to the frame surrounding the display in order to customize the apparatus and to improve its optical appearance. Still other users find it desirable to apply both a protective film to the display and a decorative film to the frame.

Apart from mobile phones, protective films or decorative films can be applied to other carriers, such as operator panels of machines, electric appliances or other articles.

In the sectional view of FIG. 2, a layer system 1 is adhesively adhered to a carrier 7. The layer system 1 comprises an application layer assembly 3 and a transport layer assembly 5. The application layer assembly 3 comprises at least one functional layer and an adhesive applied to at least portions of the functional layer. The adhesive applied to the functional layer is configured to adhesively adhere the application layer assembly 3 to the carrier 7. The functional layer may have a protective function and/or a decorative function and may have a structure such that it includes plural layers. It is the purpose of the application layer assembly 3 to permanently remain on the carrier.

The transport layer assembly 5 is provided only to support the process of applying the application layer assembly 3 to the carrier 7. For this purpose, the transport layer assembly 5 comprises a carrier layer and an adhesive applied to at least portions of the carrier layer and adhesively adhering the transport layer assembly 5 to the application layer assembly 3. The layer system 1 comprising the application layer assembly 3 and the transport layer assembly 5 is purchased by the user of the carrier and apparatus 7. For this purpose, the layer system can be enclosed in a package or envelope, and a protective film can be applied to the adhesive of the application layer assembly. This protective film can be removed in order to expose the adhesive of the application layer assembly before the layer system 1 is adhesively applied to the carrier 7 using the adhesive of the application layer assembly 3.

FIG. 1 is an elevational view of the layer system 1 and shows the transport layer assembly 5 from above. The contour of the layer system is adapted to the shape of the carrier 7, which is a mobile phone in the present example. The contour of the layer system is substantially determined by a right side 11, a bottom side 12, a left side 13, a top side 14 and rounded corners between sides 11, 12, 13 and 14. Moreover, the transport layer assembly 5 comprises a release tab 17 projecting from the top side 14 of the carrier 7 and the application layer assembly 3 such that the release tab 17 can be grasped by the hand of the user without grasping the application layer assembly 3.

The transport layer assembly further comprises a correction tab 19 projecting from the bottom side 12 of the carrier 7 and the application layer assembly 3 such that the correction tab 19 can be grasped by the hand of the user without grasping the application layer assembly 3. The functions of the release tab 17 and the correction tab 19 will be illustrated in more detail below.

FIG. 1 further shows separation lines provided in the application layer assembly 3. A circular closed separation line 21 in the application layer assembly 3 corresponds to an edge of a button 22 provided within the frame 23 of the mobile phone 7. A further separation line 25 having a shape of a closed ring corresponds to an edge of the display 27 separating the display 27 from the frame 23 of the mobile phone 7. A further separation line 29 having a rectangular closed ring shape provided in the application layer assembly 3 corresponds to an aperture of a speaker 31 of the mobile phone provided in the frame 23.

In the present example, the application layer assembly 3 provides a decorative film which is adhesively adhered to the frame 23 of the mobile phone 7 such that the frame receives a decoration and wherein the display 27, the button 22 and the aperture for the speaker 31 are not covered by the decorative film, however. The closed ring-shaped separation lines 21, and 29 allow to separate the functional layer or decorative layer, respectively, such that contiguous regions corresponding to the button 22, the display 27 and the aperture of the speaker 31 can be separated from the contiguous region corresponding to the frame 23 such that the regions of the film corresponding to the button 22, display 27 and speaker 31 can be removed from the carrier 7 while the region of the film corresponding to the frame 23 remains on the carrier. It is, however, generally possible that one or more of the closed ring-shaped separation lines do not include the application layer assembly within their interiors such that the user does not have to remove these portions of the application layer assembly by himself. It is, for example, possible that the films within the interiors of the separation lines are removed in a cutting or punching step during the manufacture of the layer system.

Moreover, it is possible to maintain a region between the separation line 21 and a line denoted by reference numeral 18 free of the adhesive attaching the functional layer to the carrier. The region between lines 22 and 18 containing no adhesive can be so small that the adhesive adherence of the functional layer to the carrier is not impaired. However, this region free of adhesive can avoid exposure of adhesive at the edge of the functional layer defined by line 21, wherein such exposed adhesive would otherwise collect dust and particles. A distance between lines 21 and 18 may amount to 1 mm or 0.5 mm, for example.

Apart from the separation lines 21, 25 and 29 of the illustrated example, further separation lines can be provided allowing for further elements, such as additional buttons, a microphone or a camera of the apparatus 7, which are not covered with the functional layer.

It is a commonly encountered problem in practice that it is difficult to apply the functional layer such to the apparatus 7 that the edges 11, 12, 13, 14, corners 15 and separation lines 21, 25 and 29 of the application layer assembly 3 are exactly registered with the respective components of the apparatus. For example, the user may have already adhered a portion of the application layer assembly 3 to the carrier 7 until he becomes aware that the application layer assembly 3 is not positioned relative to the carrier 7 as desired. A correction of this position is then required. Such correction includes releasing of the already applied portion of the application layer assembly 3 from the carrier 7, improving the position of the application layer assembly 3 relative to the carrier and re-applying the application layer assembly 3 to the carrier 7. This process can be, or has to be, repeated plural times, if necessary, until the desired position of the application layer assembly 3 relative to the carrier 7 is obtained. Only then can the transport layer assembly 5 be released from the application layer assembly 3, such that portions of the application layer assembly 3 remain on the carrier 7 as desired.

FIG. 2 shows the layer system 1 fully applied to the carrier 7 in broken lines, and, in full lines, portions of the layer system released from the carrier by pulling the tabs 17 and 19. The left side of FIG. 2 illustrates how grasping of the correction tab 19 and pulling the correction tab in a correction direction 35 can remove the layer system 1, i.e. both the transport layer assembly 5 and the application layer assembly 3, from the carrier 7 in order to subsequently correct the position of the application layer assembly 3 relative to the carrier and to re-adhere the layer system 1 to the carrier 7. Subsequent to the correct positioning of the application layer assembly 3 relative to the carrier 7 and when the layer system 1 is adhesively adhered to the carrier 7, the user may grasp the release tab 17 and pull the release tab 17 in a release direction 37 such that the transport layer assembly 5 is released from the application layer assembly 3 in order to remove the transport layer assembly 5. Herein, those portions of the application layer assembly 3 which should not remain on the carrier, may adhere to the transport layer assembly 5 such that they are removed together with the transport layer assembly 5 and only the desired portions of the application layer assembly 3 remain adhesively adhered to the carrier. For this purpose, the application layer assembly can be provided with material discontinuities, such as cuts or punches, in order to allow a separation of the portions to be removed from the portions which are to remain on the carrier.

It is apparent that the pulling of the correction tab in the correction direction 35 has a different effect than the pulling of the release tab 17 in the release direction 37. If the user pulls the correction tab 19 in the correction direction 35, both the transport layer assembly 5 and the application layer assembly 3 are removed from the carrier. If, however, the user pulls the release tab 17 in the release direction 37, the carrier layer of the transport layer assembly 5 is released from the application layer assembly 3, such that at least portions of the application layer assembly 3 remain on the carrier 7. These different effects can be achieved by adjusting the adhesive of the application layer assembly relative to the adhesive of the transport layer assembly.

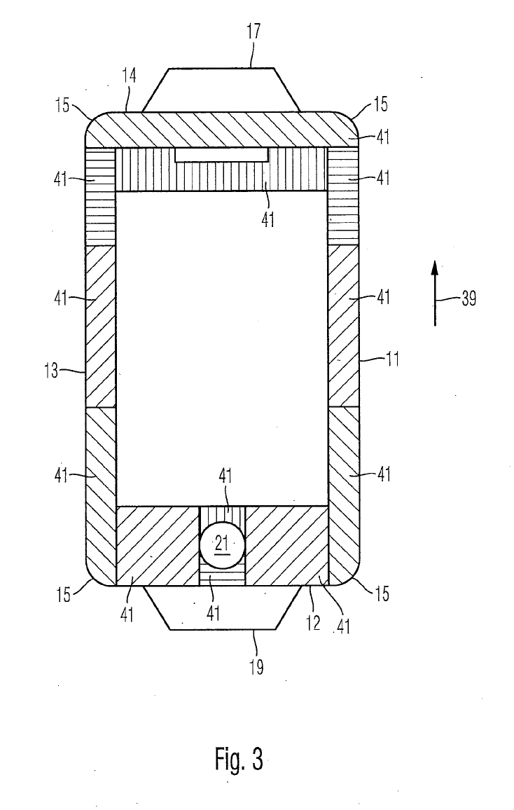

An exemplary embodiment of such adjusting of the adhesive of the application layer assembly relative to the adhesive of the transport layer assembly may include one or more regions of the transport layer assembly in which an adhesive force of the adherence of the transport layer assembly to the application layer assembly decreases in a correction direction 39 extending from the correction tab to the release tab. An exemplary configuration of such regions of the transport layer assembly 5 is schematically illustrated in FIG. 3. The various regions in which a reduction of the adhesive force of the adherence of the transport layer assembly to the application layer assembly decreases in the correction direction 39 are illustrated in FIG. 3 by four different types of hatching (horizontal, vertical, diagonal from bottom left to top right and diagonal from bottom right to top left). The different types of hatching in the figure are only provided to identify the different regions and do not indicate technical properties of these regions. In each of these regions, however, the adhesive force of the adherence of the transport layer assembly 5 to the application layer assembly 3 decreases in the correction direction 39.

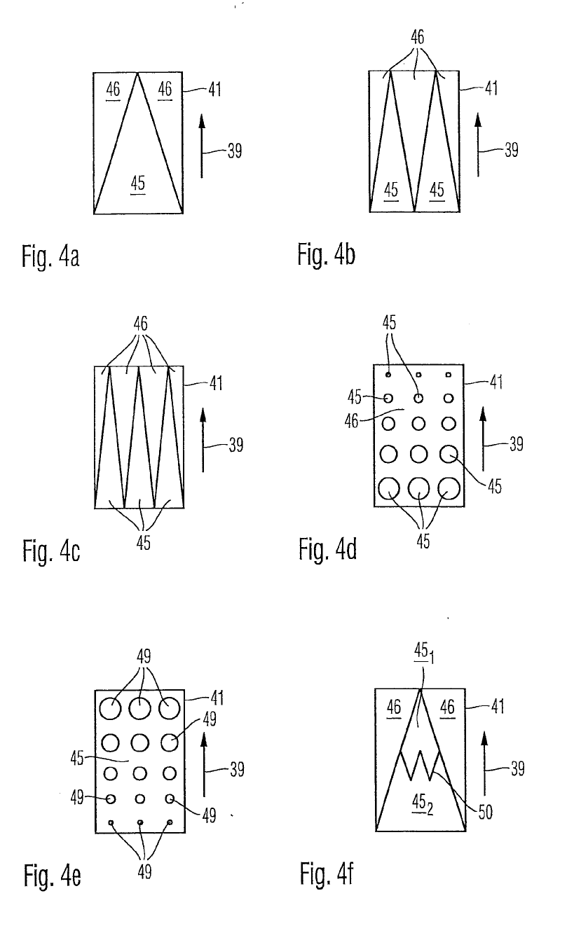

Such decrease of the adhesive force can be achieved in plural different ways, wherein some will be illustrated with reference to FIGS. 4a to 4i below. FIGS. 4a to 4i each show one region 41 in which the adhesive force of the adherence of the transport layer assembly 5 to the application layer assembly 3 decreases in the direction 39. In the illustrations of FIGS. 4a to 4i, the regions 41 each have an aspect ratio of approximately 3:4 in order to provide an exemplary illustration of the reducing adhesive force. It is apparent from FIG. 3 that the regions 41 may have different aspect ratios and may even have a geometry deviating from a rectangular geometry, as this is shown for those regions 41 adjacent to the separating line 21 corresponding to the button 22.

FIG. 4a shows an embodiment in which the adhesive adhering the transport layer assembly 5 to the application layer assembly 3 is not provided within the full surface of region 41. A surface portion of the region 41 in which the adhesive is provided is indicated by reference numeral 45 in FIG. 4a, while surface portions in which the adhesive is not provided are indicated by reference numeral 46. It is apparent that the region 45 in which the adhesive is provided has a triangular shape, wherein a width of the triangle decreases in the direction 39. This results in that a relative surface proportion of the adhesive continuously decreases in the direction 39, resulting in a continuous decrease of the adhesive force of the adherence of the transport layer assembly to the application layer assembly.

FIGS. 4b and 4c show variants of the embodiment shown in FIG. 4a. The embodiments of FIGS. 4b and 4c also include triangular regions 45 in which adhesive is provided, while adhesive is not provided in remaining regions 46. The embodiments of FIGS. 4a, 4b and 4c differ with respect to a number of the triangular regions 45 which are provided adjacent to each other when seen in a direction transverse to the direction 39. They also differ with respect to the width of the individual triangular regions.

FIG. 4d shows an embodiment in which adhesive is provided on the carrier layer in regions 45 in order to adhesively adhere the transport layer assembly to the application layer assembly, while such adhesive is not provided in a region 46 surrounding the regions 45. Compared to the embodiments of FIGS. 4a to 4c, the regions 45 in which the adhesive is provided have a circular shape rather than a triangular shape. Other shapes, differing from the circular shape, such as rectangular shapes or shapes defined by other regular or irregular polygons, are possible. The regions 45 are arranged in a regular array, wherein a diameter of the regions 45 decreases in the direction 39 in order to achieve the reduction of the adhesive force of the adherence of the transport layer assembly to the application layer assembly by reducing a surface proportion of the adhesive regions 45 relative to the total surface. This reduction occurs in steps rather than continuously.

While the reduction of the adhesive force is achieved by the reduction of the diameter of the adhesive regions 45 arranged in the rectangular array in the embodiment of FIG. 4d, variations are possible. For example, the adhesive regions 45 provided within the region 41 may all have a same diameter if the regions are arranged with a decreasing density in the direction 39 rather than the regular array arrangement. This can be achieved, for example, when the regions 45 are arranged at distances from each other which increase in the direction 39. Moreover, it is possible to arrange the adhesive regions 45 such that both their diameters and their distances from each other vary in the direction 39.

FIG. 4e shows a further embodiment in order to achieve the reduction of the adhesive force of the adherence of the transport layer assembly to the application layer assembly in the direction 39. In the embodiment of FIG. 4e, the adhesive provided on the transport layer assembly and adhering the transport layer assembly to the application layer assembly is provided in a region 45 which fully covers the region 41. However, a neutralizing agent is provided on the adhesive in regions 49. The regions 49 are arranged in a regular array, wherein diameters of the individual regions 49 increase in the direction 39, such that increasing surface proportions of the adhesive 45 are neutralized by the neutralizing agent 49 in order to achieve the reduction of the adhesive force in the direction 39. Variations of this principle are possible as well. For example, the regions 49 may all have a same diameter, while the regions 49 are provided with decreasing distances from each other in the direction 39. It is also possible to vary both the diameters and the distances of the regions 49 in which the neutralizing agent is provided in the direction 39.

It is also possible to provide a repellent agent within regions of the application layer assembly 3 in order to reduce the adhesive force of the adherence of the transport layer assembly to the application layer assembly. The regions in which the repellent agent is provided on the application layer assembly may have a similar configuration as the regions 49 shown in FIG. 4e and illustrated with reference to the neutralizing agent provided on the transport layer assembly. The regions in which the repellent agent is provided may differ from the regions in which the neutralizing agent is provided in that, for example, the repellent agent remains on the application layer assembly after removal of the transport layer assembly from the application layer assembly, while the neutralizing agent remains on the transport layer assembly when the transport layer assembly is removed from the application layer assembly.

FIG. 4f shows an embodiment similar to the embodiment illustrated with reference to FIG. 4a above and in which a region 45 in which adhesive is provided has a triangular shape with a width decreasing in the direction 39. The embodiment of FIG. 4f differs from the embodiment of FIG. 4a in that the region in which adhesive is provided includes two regions 45₁ and 45₂. The adhesive provided in the region 45₁ has a lower adhesive force than the adhesive provided in the region 45₂. Therefore, the reduction of the adhesive force of the adherence of the transport layer assembly to the application layer assembly in the direction 39 is achieved by the reduction of the surface proportion of the adhesive in the direction 39 and by different types of adhesives. A boundary line separating the regions 45₁ and 45₂ of different adhesives may have a shape differing from the shape of a straight line, as shown in FIG. 4f. FIG. 4f shows a zigzag-shape of line 50 such that a change of the adhesive force in the direction 39 does not abruptly occur at the boundary of regions 45₂ and 45₁. The change of the adhesive force occurs continuously. Herein, it is not required that the line 50 separating the regions 45₁ and 45₂ is composed of straight line portions. For example, the separating line may be composed of curved line portions, such as s-shaped line portion.

Similarly, FIGS. 4a, 4b, 4c and 4f show straight lines separating the regions 45 and 46 from each other. Also these lines can be formed from one or more curved line portions, such as s-shaped line portions. One example of such variant is shown in FIG. 4h.

FIG. 4g shows an embodiment having a geometry similar to FIG. 4a and a function similar to the embodiment of FIG. 4e. A region 49 is separated from a region 45 by straight lines, which may, however, also have curved shapes. The adhesive is provided in the region 45, while a neutralizing agent is provided in the region 49.

FIG. 4i shows an embodiment in which the adhesive force of the adherence decreases in the direction 39.

However, the decrease of the adhesive force does not occur continuously or even nearly continuously. The decrease of the adhesive force occurs abruptly in a step. The region 45 providing a high adhesive force is separated by a line oriented transversely to the direction 39 from a region 46 in which a low adhesive force is provided. For example, an adhesive having a high adhesive force can be provided in the region 45, while an adhesive providing a comparatively low adhesive force or no adhesive can be provided in the region 46.

According to an exemplary embodiment, a suitable layer system includes a transport layer assembly provided by an adhesive film having an adhesive surface to which a neutralizing agent is applied in order to provide adhesive regions and non-adhesive regions. An example of a suitable adhesive film is the film known as “tesaPACK—Crystal Clear” (EAN Code 4 042448 123855) available from Beiersdorf A G, Hamburg, Germany.

A compatible application layer assembly for application on a carrier made of glass may also include a transparent adhesive film. An example of a suitable adhesive film is the film known as “Offset Vinyl Transparent Glänzend” (CC3153) available from FASSON-Avery Dennison.

As shown in FIG. 3, plural regions 41 are arranged adjacent to each other when seen in the direction 39, wherein each region 41 provides an adhesive force reducing in the direction 39. In the illustration of FIG. 3, one single region providing a reducing adhesive force in the direction 39 is provided between the display 27 and the bottom side 12 of the mobile phone adjacent to the button 22. It is, however, also possible to provide plural such regions 41 in the direction 39 between the display 27 and the bottom side 12, such that, for example, two, five, ten, twenty or even more such regions are provided adjacent to each other in the direction 39 between the display and the bottom side 12. FIG. 3 shows plural regions 41 distributed along the right and left frame portions 11, 13. In the illustrated example, four regions 41 are provided between a bottom side 12 and the top side 14 of the mobile phone when seen in the direction 39. Also this number of regions 41 can be substantially increased. Generally, each region 41 shown in FIG. 3 can be divided both in the direction 39 and in a direction transverse to the direction 39 into a plurality of regions 41 each providing reducing adhesive forces in the direction 39.

The adhesive force decreasing in the direction 39 within the regions 41 may have an advantage in providing the different functions of the release tab 17 and the correction tab 19. When the user pulls the correction tab 19, the adhesive connection between the transport layer assembly 5 and the application layer assembly 3 is first stressed at those sides of the regions 41 at which the adhesive force is high, resulting in that the pulling of the correction tab 19 separates the adhesive connection between the application layer assembly 3 and the carrier rather than the adhesive connection between the transport layer assembly 5 and the application layer assembly 3. If, on the other hand, the user pulls the release tab 17, the adhesive connection between the transport layer assembly 5 and the application layer assembly 3 is first stressed on those sides of the regions 41 at which the adhesive force is low, such that the adhesive connection between the transport layer assembly 5 and the application layer assembly 3 is released rather than the adhesive connection between the application layer assembly 3 and the carrier 7.

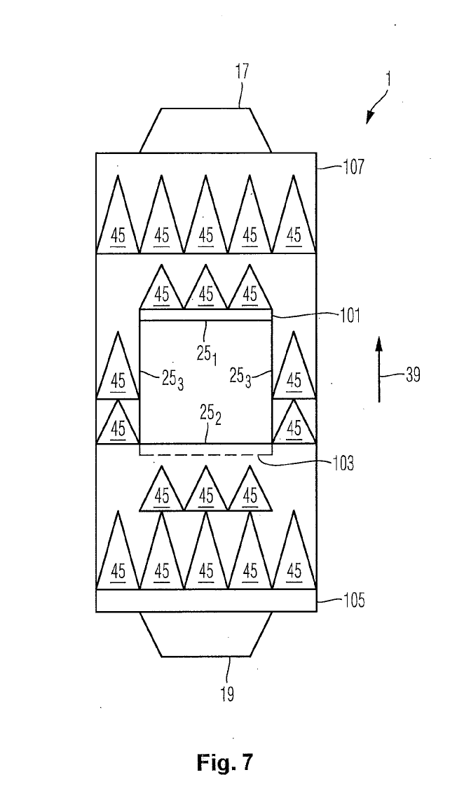

FIG. 7 shows an example of a layer system 1 in which plural regions 41 are provided in which the adhesive force of the adherence of the transport layer assembly to the application layer assembly reduces in a correction direction 39 oriented from a correction tab 19 to a release tab 17. The different adhesive forces in the respective regions 41 are achieved in a manner illustrated above with reference to FIG. 4a, wherein adhesive is provided in each region 41 only in a surface portion 45 having a width which reduces in the correction direction 39. In the illustrated embodiment, the surface portions 45 each have a triangular shape. An adhesive having a constant adhesive force is provided within the triangular surface portions 45. The surface portions 45 have an extension of 2 mm to 20 mm, for example, in a direction orthogonal to the correction direction 39.

The layer system is provided for applying a protective film onto a frame of a mobile phone, wherein the application layer assembly is not intended for application on the display of the mobile phone. For this purpose, the application layer assembly includes a window defined by a separating line 25. The separating line includes a portion 25₁ oriented orthogonally to the correction direction 39 and located closer to the release tab 17, a portion 25₂ oriented orthogonal to the correction direction 39 and located closer to the correction tab 19, and two portions 25₃ extending parallel to the correction direction 39.

A region 101 is provided immediately adjacent to the separating line 25₁ on the side facing towards the release tab 17. The region 101 extends over the full length of the separating line 25₁, and an adhesive having a high adhesive force is provided in the region 101 similar to the regions 45. The region 101 provided with the adhesive of the high adhesive force has an effect such that the application layer assembly remains adhered to the transport layer assembly when the application layer assembly is released from the carrier, i.e. the mobile phone, by pulling the correction tab 19. For the same reason, the shapes of the adhesive regions 45 adjacent to the separating line 25₁ are symmetric relative to an axis of symmetry of the separating line 25₁.

No adhesive is provided in a region 103 immediately adjacent to the separating line 25₂ on the side of the separating line 25₂ facing towards the correction tab 19. This region 103, which is free of an adhesive, provides an effect that the transport layer assembly can be reliably released from the application layer assembly when the transport layer assembly is released from the application layer assembly in the region of the separating line 25₂ by pulling the release tab 17.

A region 105 immediately adjacent to the correction tab 19 and extending across the full width of the application layer assembly is fully provided with an adhesive in order to ensure that the adhesive connection between the application layer assembly and the transport layer assembly remains intact when the release of the application layer assembly from the carrier is initiated by pulling the correction tab 19, resulting in the release of the application layer assembly from the carrier.

In a region 107 immediately adjacent to the release tab 17 and extending across the full width of the application layer assembly, there is provided no adhesive or an adhesive of only low adhesive force in order to facilitate the release of the transport layer assembly from the application layer assembly when this release is initiated by pulling the release tab 17.

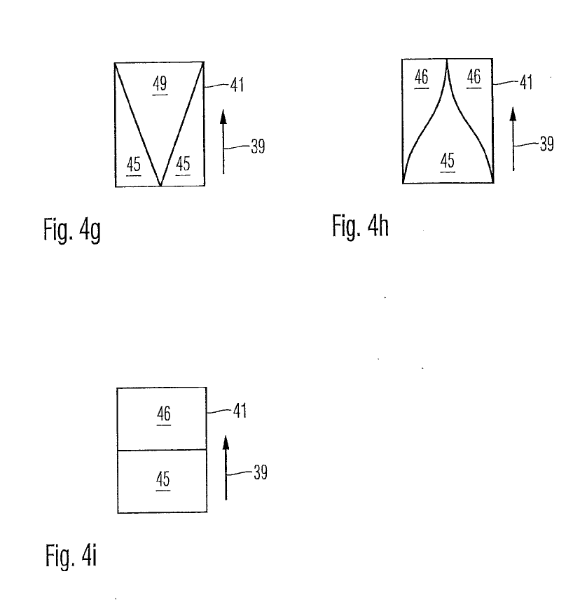

FIG. 5 is a schematic detailed exploded sectional illustration of the layer system 1 and the carrier 7 illustrated with reference to FIGS. 1 to 4 along line V-V in FIG. 1. FIG. 5 is a schematic illustration in that the individual layers and films forming the layer system and contributing to the function of the layer system are each schematically indicated having a same thickness. However, the thicknesses of the individual layers and films can largely differ in practice.

The application layer assembly 3 comprises a base film 50 onto which a color layer 53 is printed. A layer 55 of an adhesive is applied to the color layer 53 in order to provide a connection between the base film 50 including the print layer 53 and a transparent protective film 57. Herein, it is also possible that the adhesive 55 and the protective film 57 are replaced by a printed or applied layer of a UV-protective paint. The layers 50, 53 and 57 can be referred to as functional layers since they provide the functions which are to be provided to the carrier 7. These functions include the decorative function achieved by the imprint 53 on the base film 50, and the protective function achieved by the protective film 57. The functional layers 50 to 57 are adhered to the carrier 7 by an adhesive 59 provided on the base film 50. Herein, the functional layers are to be adhered only to the frame 23 and not to the button 22, the display 27 and the aperture 31 for the speaker. For this reason, a neutralizing agent 61 is provided on the adhesive 59 in those regions in which the adhesive 59 should not fulfill its adhesive function. In particular, the neutralizing agent 61 is provided in those regions of the adhesive 59 which are registered with the button 22, the display 27 and the aperture 31 when the application layer assembly 3 is correctly positioned relative to the carrier.

The outer edges of the neutralizing agent 61 coincide with the separating lines 21, 25 and 29. A material discontinuity extends along the separating lines in at least one of the functional layers 50, 53, 55, 57, 59 of the application layer assembly 3. In the example shown in FIG. 5, the material discontinuities are provided by cuts 63 extending along the separating lines. The cuts 63 may be provided by a cutting tool and may extend through all or some or only one of the functional layers of the application layer assembly 3. The cuts 63 disrupt the integrity of the functional layers, such that those portions of the functional layers which are located within the separating lines 21, 25 and 29 can be removed since the adhesive 59 is neutralized by the neutralizing agent 61 within the closed ring shaped separating lines, such that the functional layers have a relatively low adherence to the carrier 7 within the regions defined by the closed ring shaped separating lines.

In the embodiment illustrated with reference to FIG. 5, those regions of the application layer assembly 3 which are located within the closed ring shaped separating lines 21, 25, 29 are removed together with the transport layer assembly 5. The transport layer assembly 5 comprises a carrier layer 67 also providing the release tab 17 and the correction tab 19, and an adhesive layer 69 adhesively adhering the transport layer assembly 5 to the application layer assembly 3. Due to this adhesive adherence of the transport layer assembly to the application layer assembly, those portions of the application layer assembly 3 which are located within the closed ring shaped separating lines 21, 25 and 29 are removed from the carrier when the transport layer assembly 5 is released from the application layer assembly 3, since the material discontinuities 63 along the separating lines disrupt the integrity within the layers 50 to 59 and since the adhesive force of the adhesive of the layer 59 is reduced by the neutralizing agent 61.

In the illustrated example, the release tab and the correction tab are integrally formed with the carrier layer. It is, however, also possible to provide the release tab and/or the correction tab by elements which are separate from the carrier layer but which are fixedly connected to the carrier layer by an adhesive, for example.

In the illustrated example, the transport layer assembly 5 comprises a layer 71 of a neutralizing agent in order to adjust the adhesive force of the adherence of the transport layer assembly 5 to the application layer assembly 3 and, in particular, in order to provide regions illustrated with reference to FIGS. 3 and 4 above in which the adhesive force decreases in the direction 39. In the illustrated example, the adhesive force is adjusted by applying a neutralizing agent to the adhesive which is provided on the full surface of the carrier layer. It is, however, also possible to adjust the adhesive force differently as, for example, illustrated with reference to FIGS. 4a to 4h above. It is, in particular possible, to provide the adhesive only in selected regions rather than on the full surface of the carrier layer.

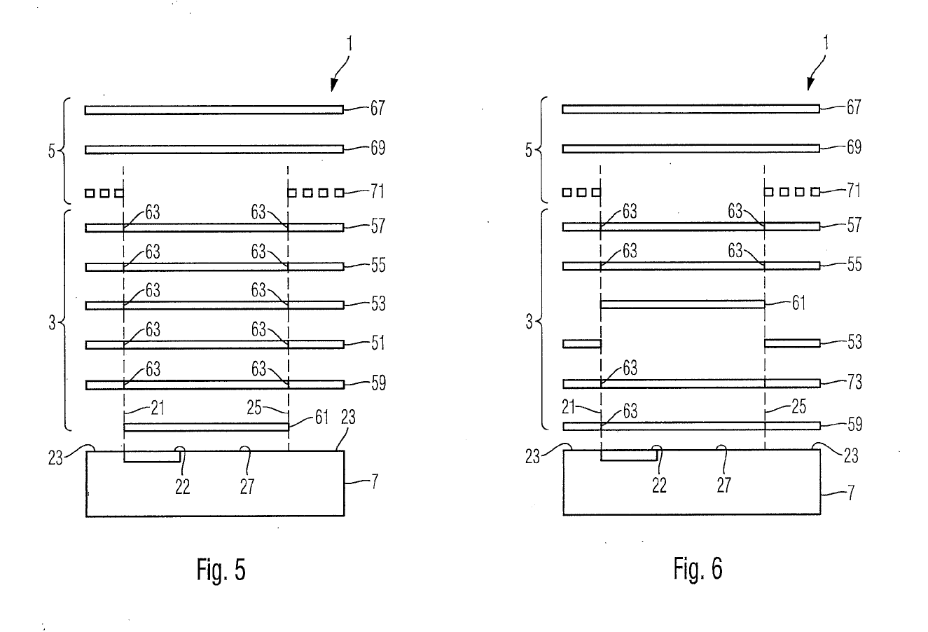

FIG. 6 is a further exploded sectional view along line
V-V in FIG. 1 of a further embodiment of a layer system 1 having a slightly different configuration than the embodiment illustrated with reference to FIG. 5.

The layer system 1 of FIG. 6 comprises a transport layer assembly 5 including a carrier layer 67, an adhesive layer 69 and a layer 71 of a neutralizing agent.

The application layer assembly 3 comprises a functional layer 73 which is a light transparent protective film, the full surface of which is adhered to the carrier by an adhesive layer 59, such that both the frame 23 and the display 27 and the button 22 are covered. For this reason, a neutralizing agent (reference numeral 61 in FIG. 5) is not provided between the adhesive layer 59 and the carrier 7 in order to not allow the removal of the functional layer from the button 22 and the display 27. Moreover, material discontinuities 63 are not provided in the functional layer 73 between the display 27 and the frame 23 since the protective film 73 should extend continuously from the display 27 to the frame 23.

However, cuts 63 are provided along the line 21 surrounding the region of the button 22. This material discontinuity 63 is provided in order to allow operation of the button 22.

In those regions of the protective film 73 which are registered with the frame 23 outside of the button 22, a functional layer 53 provided by a printing color is applied to the protective film 73 in order to provide a decoration of the frame 23. A protective film 57 is connected to the printed color layer 53 by an adhesive layer 55. A neutralizing agent 61 is provided between the adhesive layer 55 and the printed color layer 53 and the protective film 73 in the region registered with the display 27 and the button 22. Material discontinuities 63 are provided in the protective film and the adhesive layer 55 along the separating lines 21 and 25, such that the protective film 57, the adhesive layer 55 and the neutralizing agent 61 can be removed together with the transport layer assembly 5 in the regions of the display 27 and the button 22.

The protective film 57 can be omitted together with the adhesive layer 55 in some variants of the layer system. It may then be helpful to provide the printed color layer 53 between the protective film 73 and the adhesive layer 59.

The color and printed layers of the application layer assembly can be manufactured in all possible known ways. For example, methods of UV-flexo printing, gravure printing, UV-offset printing, screen printing, EB-offset printing and other printing technologies can be used. The abbreviation “UV” stands for “ultraviolet” and designates a method of initiating a bonding reaction or drying reaction of printing colors using ultraviolet light. The abbreviation “EB” stands for “electron beam” and designates the initiating of such reactions using an electron beam.

In order to adjust the adhesive forces between the individual layers, plural methods are available. For example, a surface of a layer on which the adhesive is applied can be roughened in order to increase the adherence of the adhesive to this layer. Moreover, a neutralizing agent, such as a silicone layer, can be applied to an underlying layer in order to reduce the adherence of the adhesive to this underlying layer.

The protective layers illustrated in the above embodiments can be made of PVC. One example of such material is “Clear vinyl” available from 3M, St. Paul, Minn., USA. Moreover, a combination of a protective film and an adhesive film can be obtained under the product name “Scotchcal™ Overlaminate 8580” from 3M.

The protective function can also be achieved by a protective paint which can be sprayed onto an underlying layer or which can be applied to the underlying layer by a printing method, such as screen printing. Suitable protective paints are, for example, available under the product name “Scotchcal 1920DR” from 3M.

Moreover, the protective paint can be blended with silicone in order to extend the performance of the protective paint.

Adhesive layers can be applied to underlying layers by laminating, for example.

The thickness of the application layer assembly illustrated with reference to FIG. 5 and which does not include a protective layer for the display, may, for example, amount to less than 0.14 mm, less than 0.20 mm and, in particular, less than 0.08 mm. The thickness of the application layer assembly illustrated with reference to FIG. 6 and which includes a protective layer for the display, may, for example, amount to less than 0.30 mm, less than 0.20 mm or less than 0.15 mm. According to the currently available technology, lower limits of the thickness of the application layer assembly can be estimated to 0.001 mm, 0.005 mm or 0.01 mm, wherein low available thicknesses should not be excluded for the future.

What is claimed is:

1. A layer system for application to a carrier for protective or decorative purposes, wherein the layer system comprises:
an application layer assembly comprising at least one functional layer and an adhesive applied to at least a portion of the functional layer and configured to adhesively adhere the application layer assembly to the carrier; and
a transport layer assembly comprising at least one carrier layer and an adhesive applied to at least a portion of the carrier layer and adhesively adhering the transport layer assembly to the application layer assembly;
wherein the transport layer assembly comprises a release tab and a correction tab provided at different sides of the transport layer assembly and which extend beyond the application layer assembly such that they can be grasped by the hand of a user without grasping the application layer assembly; and
wherein the adhesive of the application layer assembly and the adhesive of the transport layer assembly are adjusted relative to each other such that the application layer assembly can be released from the carrier by pulling at the correction tab while the adhesive adherence of the transport layer assembly to the application layer assembly is maintained, and such that the transport layer assembly can be released from the application layer assembly by pulling at the release tab while the adhesive adherence of the application layer assembly to the carrier is maintained.

2. The layer system according to claim 1, wherein the transport layer assembly includes at least one region in which an adhesive force of the adhering of the transport layer assembly to the application layer assembly decreases in a correction direction extending from the correction tab to the release tab.

3. The layer system according to claim 2, wherein an adhesive force of the adhesive of the transport layer assembly decreases in the correction direction in the at least one region.

4. The layer assembly according to claim 2, wherein a neutralizing agent is provided in at least some portions between the adhesive of the transport layer assembly and the application layer assembly in order to reduce an adhesive force of the adhesive of the transport layer assembly.

5. The layer system according to claim 2, wherein a repelling agent is provided in at least some portions of the application layer assembly in order to reduce the adhesive force of the adhesive of the transport layer assembly.

6. The layer system according to claim 2, wherein, in the at least one region, a surface proportion in which the adhesive is provided on the carrier layer decreases in the correction direction.

7. The layer system according to claim 2, wherein the at least one region has an extension in a direction transverse to the correction direction within at least one of a range from 2 mm to 20 mm, a range from 2 mm to 10 mm, and a range from 3 mm to 10 mm.

8. The layer system according to claim 1, further comprising one or more material discontinuities of the functional layer extending along at least one separation line wherein at least a portion of the at least one separation line extends in a direction transverse to the correction direction.

9. The layer system according to claim 8, wherein the adhesive force of the adherence of the transport layer assembly to the application layer assembly is smaller on a side of the separation line facing towards the release tab than on a side of the separation line facing towards the correction tab.

10. The layer system according to claim 8, wherein, in a first surface portion immediately adjacent to the separation line on a side facing towards the correction tab, the adhesive force of the adherence of the transport layer assembly to the application layer assembly has a value smaller than 0.2 times a maximum adhesive force of the adherence of the transport layer assembly to the application layer assembly.

11. The layer system according to claim 8, wherein, in a second surface portion immediately adjacent to the separation line on a side facing towards the release tab, the adhesive force of the adherence of the transport layer assembly to the application layer assembly has a value greater than 0.8 times a maximum adhesive force of the adherence of the transport layer assembly to the application layer assembly.

12. The layer system according to claim 8, wherein the separation line has a shape of a closed ring and wherein the material discontinuity extends continuously along the separation line or wherein a plurality of spaced apart material discontinuities extend along the separation line.

13. The layer system according to claim 1, wherein, in a third surface portion immediately adjacent to the correction tab, the adhesive force of the adherence of the transport layer assembly to the application layer assembly has a value greater than 0.8 times a maximum adhesive force of the adherence of the transport layer assembly to the application layer assembly.

14. The layer system according to claim 1, wherein, in a fourth surface portion immediately adjacent to the release tab, the adhesive force of the adherence of the transport layer assembly to the application layer assembly has a value smaller than 0.2 times a maximum adhesive force of the adherence of the transport layer assembly to the application layer assembly.

15. The layer system according to claim 1, wherein the functional layer of the application layer assembly includes a light transparent protective layer and a decorative layer provided between the protective layer and the adhesive of the application layer assembly.

16. The layer system according to claim 1, wherein a thickness of the application layer assembly is less than at least one of 0.5 mm, 0.14 mm, 0.10 mm and 0.08 mm.

17. The layer system according to claim 1, wherein the functional layer of the application layer assembly includes a light transparent protective layer, and wherein a thickness of the application layer assembly is less than at least one of 0.30 mm, 0.20 mm and 0.15 mm.

18. The layer system according to claim 1, wherein a thickness of the application layer assembly is greater than at least one of 0.001 mm, 0.005 mm and 0.01 mm.

19. A method of adhering an application layer assembly to a carrier, wherein a method comprises:
adhering a layer system to the carrier, wherein the layer system comprises an application layer assembly and a transport layer assembly, wherein the application layer assembly comprises at least one functional layer and an adhesive applied to at least a portion of the functional layer and configured to adhesively adhere the application layer assembly to the carrier, and wherein the transport layer assembly comprises at least one carrier layer and an adhesive applied to at least a portion of the carrier layer and adhesively adhering the transport layer assembly to the application layer assembly;
correcting a position of the layer system relative to the carrier by releasing the adhesive adherence of the application layer assembly to the carrier by pulling at least one tab of the transport layer assembly in a first direction;
re-adhering of the layer system to the carrier; and
releasing the transport layer assembly from the application layer assembly by pulling the at least one tab of the transport layer assembly in a second direction different from the first direction.

20. The method according to claim 19,
wherein the correcting of the position comprises pulling at a correction tab of the transport layer assembly provided on a first side of the transport layer assembly, and
wherein the releasing of the transport layer assembly comprises pulling at a release tab of the transport layer assembly provided at a second side of the transport layer assembly, wherein the second side is different from the first side.

21. The method according to claim 20, wherein the correction tab and the release tab are provided on opposite sides of the transport layer assembly.
